(19) United States
(12) Patent Application Publication
(10) Pub. No.: US 2023/0237702 A1
(43) Pub. Date: Jul. 27, 2023

(54) METHOD OF DEPLOYING MULTIPLE MONITORING DEVICES

(71) Applicant: JORJIN TECHNOLOGIES INC., New Taipei City (TW)

(72) Inventors: Wen-Hsiung Lin, New Taipei City (TW); Kai-Pin Tung, New Taipei City (TW); Chih-Yuan Chu, New Taipei City (TW)

(21) Appl. No.: 17/586,739

(22) Filed: Jan. 27, 2022

(51) Int. Cl. G06T 7/80; H04N 7/18; G01S 13/89

(52) U.S. Cl. CPC G06T 7/80; H04N 7/18; G01S 13/89

(57) ABSTRACT

The method includes a data collection step, a setup step, a positioning step, an analysis step, and an adjustment step. The data collection step collects spatial data about a scene to be monitored. The setup step installs a number of monitoring devices and a reference device, where the reference device includes a reflector or a calibration pattern. The positioning step determines respective positions of the monitoring devices relative to the reference device. The analysis step determines whether the FOVs of the monitoring devices jointly cover the scene by an algorithm module analyzing the scene data, the FOVs of the monitoring devices, and the relative positions of the monitoring devices against the reference device. The adjustment step provides suggestions about adding one or more monitoring devices or changing positions of the monitoring devices to cover the scene entirely if the FOVs of the monitoring devices do not cover the scene.

### BACKGROUND OF THE INVENTION

### (a) Technical Field of the Invention

The present invention is generally related to surveillance and monitoring, and more particular to a method of deploying multiple monitoring devices.

### (b) Description of the Prior Art

To conduct aerial surveillance, some aerial monitoring device, e.g., millimeter wave radar or camera, has to be deployed. Taking the China Patent No. CN111510665B as an example, this application provides a monitoring system, a monitoring method a d a device for a millimeter wave radar and a camera. The system includes a millimeter wave radar for collecting feature information of a target human body, and the feature information includes the physical information of the target human body. The feature information of the target human body is sent to the camera. The camera, based on the physical information of the target human body; identifies whether there is an image containing a specified posture in an image frame sequence containing the target human body collected within a preset time period, and if so, determining the target image frame for output from the image frame sequence. The target image frame is an image containing the specified posture.

Monitoring devices all have a certain field of view (FOV). An object outside the FOV will not be monitored, meaning that all monitoring devices have blind spots. A single millimeter wave radar or camera therefore has a limited coverage. Usually, multiple millimeter wave radars or cameras are deployed with overlapping FOVs to achieve a more complete coverage.

To set up multiple millimeter wave radars or cameras, they are initially installed by experience and then gradually adjusted (or more devices are included) to achieve a greater coverage. The adjustment or addition is often ineffective and inefficient as there is no precise data as guidance.

### SUMMARY OF THE INVENTION

To obviate the shortcoming of prior methods, the present invention teaches a method of deploying multiple monitoring devices including a data collection step, a setup step, a positioning step, an analysis step, and an adjustment step. The data collection step collects spatial data about a scene to be monitored, where the spatial data includes the scene's length, depth, and height. The setup step installs a number of monitoring devices and a reference device, where the reference device includes a reflector or a calibration pattern, and each monitoring device has a field of view (FOV). The positioning step determines respective positions of the monitoring devices relative to the reference device through the monitoring devices' detecting the reflector or the calibration pattern. The analysis step determines whether the FOVs of the monitoring devices jointly cover the scene by an algorithm module analyzing the scene data, the FOVs of the monitoring devices, and the relative positions of the monitoring devices against the reference device. The adjustment step provides suggestions about adding one or more monitoring devices or changing positions of the monitoring devices to cover the scene entirely if the FOVs of the monitoring devices do not cover the scene.

Each of the monitoring devices is a millimeter wave radar or an optical camera.

Alternatively, all monitoring devices are millimeter wave radars or optical cameras.

The reflector is a corner reflector, a Luneburg lens reflector, or a ball reflector.

The calibration pattern is a chessboard pattern, an ArUco pattern, or a ChArUco pattern.

When a millimeter wave radar is used, the reflector is adopted. The millimeter wave radar, based on a traversal time of a radio wave transmitted by the millimeter wave radar and reflected back by the reflector, a position of the millimeter wave radar comprising distance, angle, and height, relative to the reflector is determined.

When an optical camera is used, the calibration pattern is adopted. The optical cameras captures an image of the calibration pattern according to a method of camera calibration. The calibration pattern has an actual location in the scene and a pixel location in the image. According to a correspondence relation between the actual and pixel locations, the position of the optical camera relative to the calibration pattern is determined.

The setup step further includes providing a turntable on the reference device, and placing the reflector or the calibration pattern on the turntable.

As described above, the method is capable of providing precise data as guidance to adjust or add more monitoring devices so that their FOV may cover the entire scene without blind spot.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the steps of a method of deploying multiple monitoring devices according to an embodiment of the present invention.

FIG. 2 is a schematic diagram showing the field of views (FOVs) of a number of millimeter wave radars.

FIG. 3 is a schematic diagram showing radio wave transmitted from the millimeter wave radars of FIG. 2 to a reflector.

FIG. 4 is a schematic diagram showing a reflector spun by a turntable.

FIG. 5 is a schematic diagram showing the FOVs of a number of optical camera.

FIG. 6 is a schematic diagram showing a calibration pattern shot by the optical cameras of FIG. 5.

FIG. 7 is a schematic diagram showing a calibration pattern spun by a turntable.

FIG. 8 is a schematic diagram showing the FOVs of a number of millimeter wave radars and optical cameras.

FIG. 9 is a schematic diagram showing radio wave transmitted from the millimeter wave radars of FIG. 8 to a reflector and a calibration pattern shot by the optical cameras of FIG. 8.

FIG. 10 is a schematic diagram showing a reflector and a calibration pattern spun by a turntable.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement. of the elements described without departing from the scope of the invention as set forth in the appended claims.

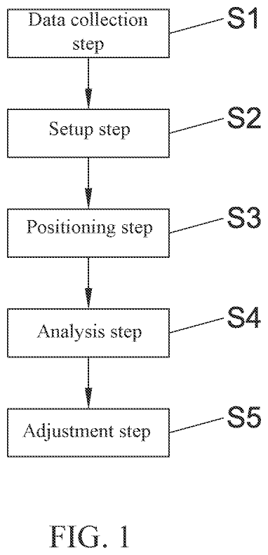

As shown in FIG. 1, a method of deploying multiple monitoring devices according to an embodiment of the present invention includes the following steps: a data collection step S1, a setup step S2, a positioning step S3, an analysis step S4, and an adjustment step S5.

The data collection step S1 collects spatial data about a scene to be monitored, where the spatial data includes the scene's length, depth, and height.

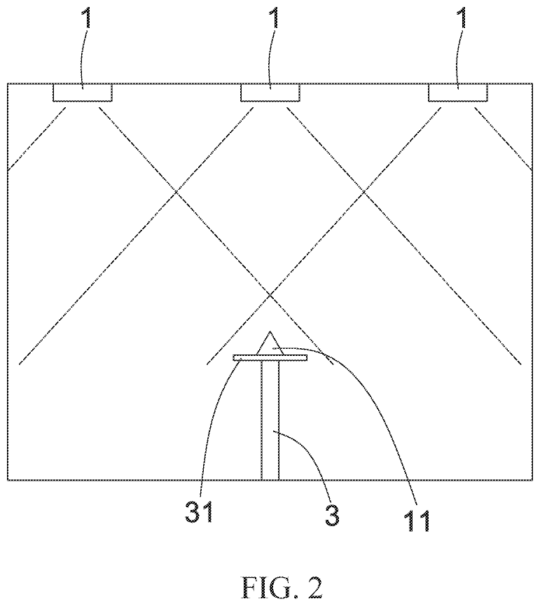

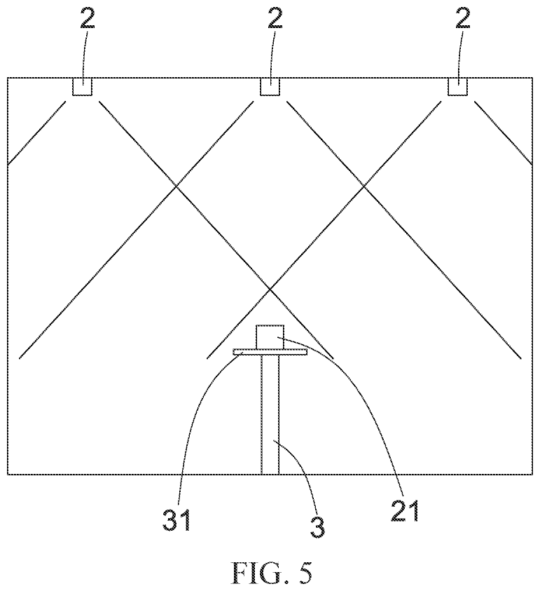

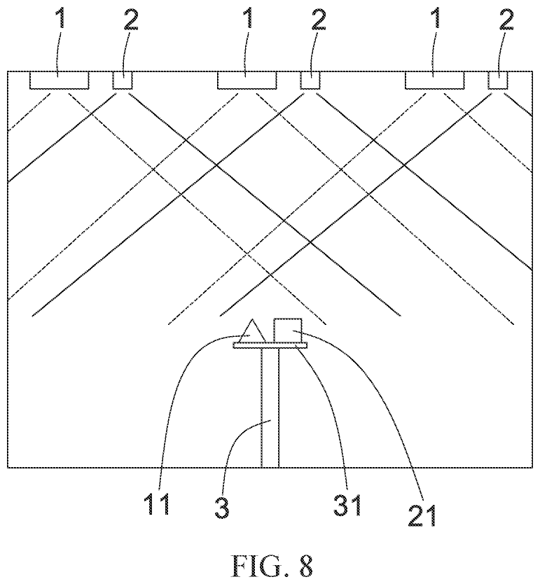

FIG. 2 is a schematic diagram showing the field of views (FOVs) of a number of millimeter wave radars. FIG. 5 is a schematic diagram showing the FOVs of a number of optical cameras. FIG. 8 is a schematic diagram showing the FOVs of a number of millimeter wave radars and optical cameras.

The setup step S2 installs a number of monitoring devices, each having a FOV, and a reference device 3. The reference device 3 includes a reflector 11 or a calibration pattern 21. Specifically, the monitoring devices may all be millimeter wave radars for optical cameras 2, or some monitoring devices are millimeter wave radars 1 and some monitoring devices are optical cameras 2.

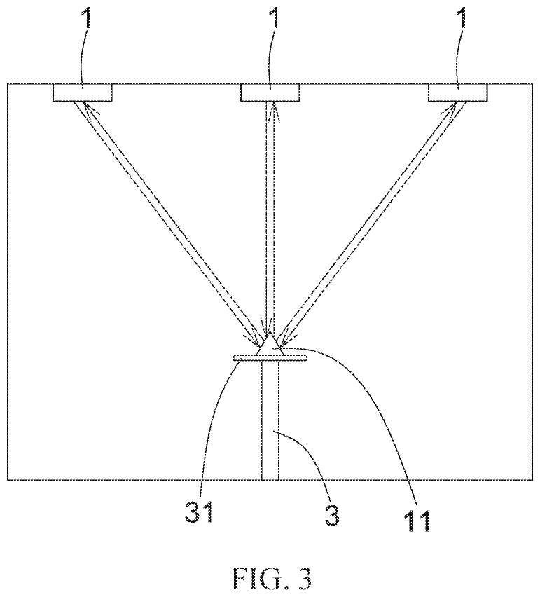

FIG. 3 is a schematic diagram showing radio wave transmitted from the millimeter wave radars to the reflector. When the monitoring devices are millimeter wave radars 1, the reflector 11 should be employed. The reflector 11 may be a radar reflector to reflect the radio wave from the millimeter wave radars 1, The radar reflector may be a corner reflector, a Luneburg lens reflector, or a ball reflector. The corner reflector includes three mutually perpendicular plates of high radio reflectivity. Radio wave from a millimeter wave radar 1 incident at a specific angle would be almost entirely reflected back to the millimeter wave radar 1. The millimeter wave radar 1 as such may determine the location of the corner reflector. The Luneburg lens reflector is a spherical reflector coated with a metallic layer. Radio wave from a millimeter wave radar 1 may be reflected along the same incident path.

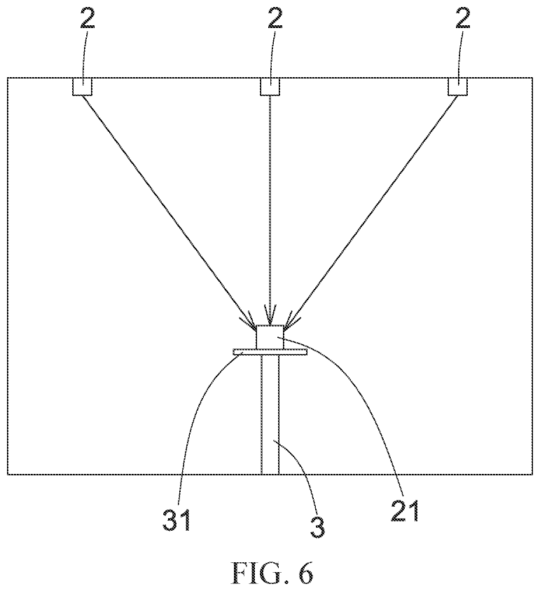

FIG. 6 is a schematic diagram showing the reflector shot by the optical cameras 2. When the monitoring devices are optical camera 2, the calibration pattern 21 should be employed. The calibration pattern 21 may be a chessboard pattern, an ArUco pattern, or a ChArUco pattern. For example, a chessboard pattern has alternating squares in dark and light colors arranged in an array. Each square represents a 3D coordinate.

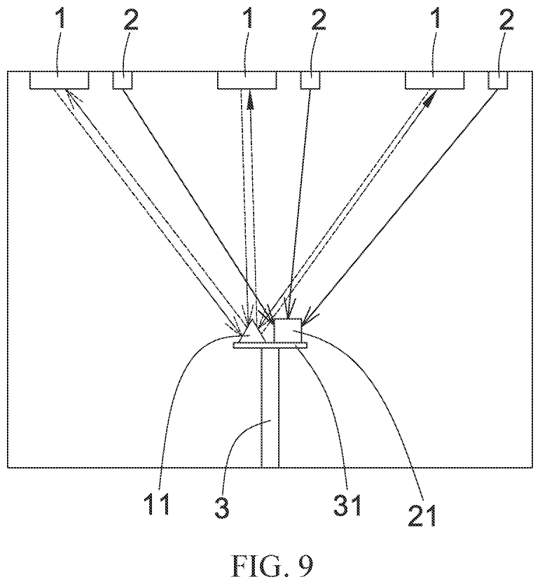

A user may choose to use millimeter wave radars 1 along with a reflector 11, or to use optical cameras 2 along with a calibration pattern 21. Alternatively, as shown in FIG. 9, if both millimeter wave radars 1 and optical cameras 2 are employed, both a reflector 11 and a calibration pattern 21 should be adopted.

As shown in FIGS. 2 and 5, the FOV of each monitoring device indicates that an object can only be detected or shot by the monitoring device when it is located within a coverage of the monitoring device. An object outside this coverage of FOV cannot be detected or shot by the monitoring device. In other words, each millimeter wave radar 1 can only detect, and each optical camera 2 can only shoot, objects within its FOV.

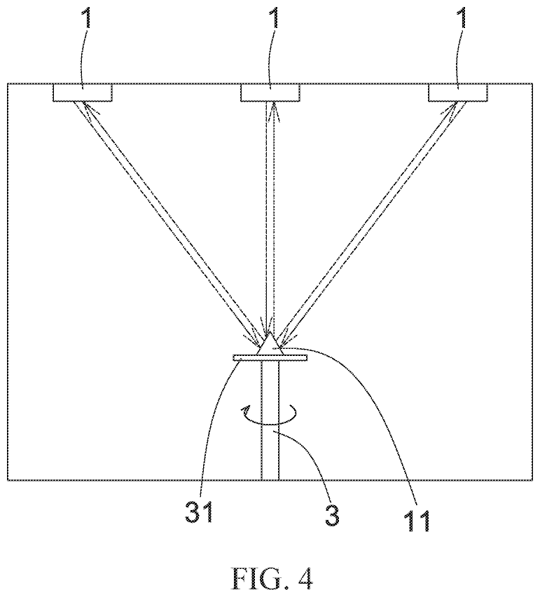

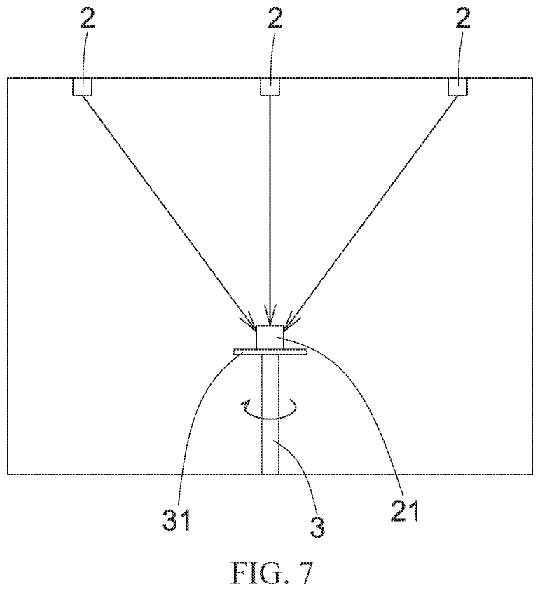

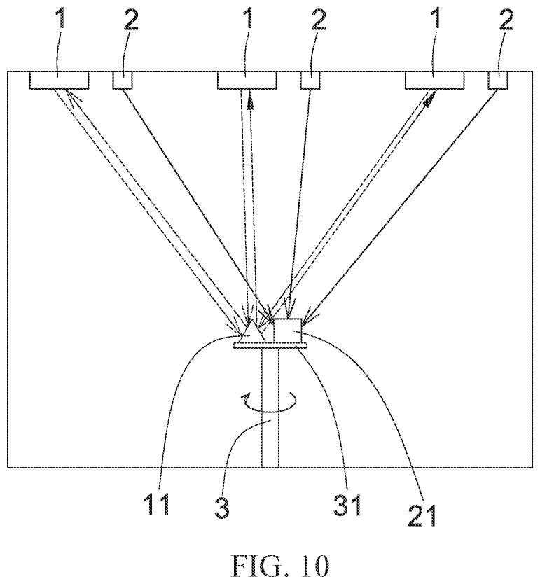

FIG. 4 is a schematic diagram showing the reflector spun by a turntable. FIG. 7 is a schematic diagram showing the calibration pattern spun by the turntable. FIG. 10 is a schematic diagram showing a reflector and a calibration pattern spun by a turntable.

The setup step may also include having a turntable 31 on the reference device 3 where the reflector 11 or the calibration pattern 21 is positioned. The turntable 31 spins the reflector 11 or the calibration pattern 21 so that the monitoring devices detects or shoots the reflector 11 or the calibration pattern 21 from different angles.

As shown in FIGS. 1, 3, and 6, the positioning step S3 determines the respective positions of the monitoring devices relative to the reference device 3.

As shown in FIG. 3, when the monitoring devices are millimeter wave radars 1, the millimeter wave radars 1, based on the traversal times of their respective radio wave reflected back by the reflector 11, may determine their respective positions (including distances, angles, and heights) relative to the reflector 11.

As shown in FIG. 4, by spinning the reflector 11 by the turntable 31, the monitoring devices may detect the reflector 11 from varying angles. According to the Doppler effect, the reflected radio wave from the reflector 11 may undergo frequency and amplitude changes, depending the movement of the reflector 11. For example, if the reflector 11 approaches a millimeter wave radar 1, the reflected radio wave would have a higher frequency. If the reflector 11 moves away from a millimeter wave radar 1, the reflected radio wave would have a lower frequency. Based on the frequency difference between the transmitted and reflected radio wave, the spinning speed of the reflector 11 may be determined The relative positions of the millimeter wave radars 1 against the reference device 3 may then be determined.

As shown in FIG. 6, when the monitoring devices are optical cameras 2, the optical cameras 2 captures an image of the calibration pattern 21 according to a method of camera calibration. The calibration pattern 21 has an actual location in the scene and a pixel location in the image. According to the correspondence relation between the actual and pixel locations, the respective positions of the optical cameras 2 relative to the calibration pattern 21 (i.e., reference device 3) may he determined.

As the 3D scene and the 2D image are of different dimensions, the method of camera calibration is conducted to achieve dimension conversion and to establish correspondence therebetween. Then, what occurs in the 3D scene can be reconstructed by multiple images subsequently taken.

The method of camera calibration is as follows.

Step 1: converting a world coordinate system into a camera coordinate system through principle of lens imaging, which includes scaling, rotation, and translation, where the world coordinate system is the 3D coordinate system of the real world and the camera coordinate system is another 3D coordinate system presented in an optical camera 2.

Step 2: converting the camera coordinate system into an image coordinate system, also known as projection, Where 3D coordinate system is projected to a screen's 2D coordinate system without the dimension of height.

Step 3: sampling the image coordinates into pixel coordinates discretely, where the pixel coordinates are also 2D coordinates.

Camera calibration is a known prior art and not the main gist of the present invention. The detail is, therefore, omitted here.

As shown in FIGS. 1, 3, and 6, the analysis step S4 combines the FOVs of the monitoring devices and determines whether these overlapped FOVs of the monitoring devices cover the scene by an algorithm module's analyzing the scene data, the FOVs of the monitoring devices, the relative positions of the monitoring devices against the reference device 3. Specifically, the algorithm model establishes a geometric model of the scene using the scene data, locates the positions of the monitoring devices in the geometric model based on their relative positions against the reference device 3, and overlaps the FOVs of the monitoring devices in the geometric model to see if there is any blind spot. If there is blind spot, the algorithm module provides adjustment suggestion according to the scene data, the FOVs of the monitoring devices, and the relative positions of the monitoring devices against the reference device 3.

The adjustment step S5 suggests the addition of more monitoring devices or the position change to the monitoring devices to cover the scene if the existing FOVs of the monitoring devices do not cover the entire scene. A user then can install one or more monitoring devices or change the positions of the monitoring device according to the suggestion provided by the algorithm module, thereby significantly reducing the time and effort in trial and error and enhancing the perfonnance and precision of the scene's surveillance.

While certain novel features of this invention have been shown and described and are pointed out in the annexed claim, it is not intended to be limited to the details above, since it will be understood that various omissions, modifications, substitutions and changes in the and details of the device illustrated and in its operation can be made by those skilled in the art without departing in any way from the claims of the present invention.

I claim:

1. A method of deploying multiple monitoring devices, comprising:
a data collection step: collecting spatial data about a scene to be monitored, where the spatial data includes the scene's length depth, and height;
a setup step: installing a plurality of monitoring devices and a reference device, where the reference device comprises a reflector or a calibration pattern, and each monitoring device has a field of view (FOV);
a positioning step: determining respective positions of the monitoring devices relative to the reference device through the monitoring devices detecting the reflector or the calibration pattern;
an analysis step: determining whether the FOVs of the monitoring devices jointly cover the scene by an algorithm module analysing the scene data, the FOVs of the monitoring devices, and the relative positions of the monitoring devices against the reference device; and
an adjustment step: providing suggestions about adding one or more monitoring devices or changing positions of the monitoring devices to cover the scene entirely if the FOVs of the monitoring devices do not cover the scene.

2. The method of deploying multiple monitoring devices according to claim 1, wherein each of the monitoring devices is a millimeter wave radar or an optical camera.

3. The method of deploying multiple monitoring devices according to claim 1, wherein all monitoring devices are millimeter wave radars or optical cameras.

4. The method of deploying multiple monitoring devices according to claim 1, wherein the reflector is a corner reflector, a Luneburg lens reflector, or a ball reflector.

5. The method of deploying multiple monitoring devices according to claim 1, wherein the calibration pattern is a chessboard pattern, an ArUco pattern, or a ChArUco pattern.

6. The method of deploying multiple monitoring devices according to claim 2, wherein, when a millimeter wave radar is used, the reflector is adopted; and the millimeter wave radar, based on a traversal time of a radio wave transmitted by the millimeter wave radar and reflected back by the reflector, a position of the millimeter wave radar comprising distance, angle, and height, relative to the reflector is determined.

7. The method of deploying multiple monitoring devices according to claim 2, wherein, when an optical cameras is used, the calibration. pattern is adopted; the optical cameras captures an image of the calibration pattern according to a method of camera calibration; the calibration pattern has an actual location in the scene and a pixel location in the image; and, according to a correspondence relation between the actual and pixel locations, the position of the optical camera relative to the calibration pattern is determined.

8. The method of deploying mulfiple monitoring devices according to claim 1, wherein the setup step further comprises providing a turntable on the reference device, and placing the reflector or the calibration pattern on the turntable.
